(19) United States
(12) Patent Application Publication
(10) Pub. No.: US 2025/0159574 A1
(43) Pub. Date: May 15, 2025

(54) SECONDARY CELL ACTIVATION AND DEACTIVATION

(71) Applicant: Nokia Technologies Oy, Espoo (FI)

(72) Inventors: Chunli WU, Beijing (CN); Samuli Heikki TURTINEN, Oulu (FI); Tero HENTTONEN, Espoo (FI); Lars DALSGAARD, Oulu (FI); Jarkko Tuomo KOSKELA, Oulu (FI)

(21) Appl. No.: 18/722,210

(22) PCT Filed: Dec. 22, 2021
(86) PCT No.: PCT/CN2021/140636

§ 371 Date: Jun. 20, 2024

(51) Int. Cl. H04W 36/06; H04W 24/02; H04W 52/02

(52) U.S. Cl. CPC H04W 36/06; H04W 24/02; H04W 52/0261

(57) ABSTRACT

Embodiments of the present disclosure relate to methods, devices, apparatuses, and computer readable medium of secondary cell activation and deactivation. The method comprises: receiving, at a terminal device, an indication of deactivating a serving cell of the terminal device, the serving cell being provided by a second network device; determining a switching from an active bandwidth part, BWP, to a target BWP to be performed on the serving cell; and switching from the active BWP to the target BWP on the serving cell. Upon the SCell deactivation, the UE determines whether to switch from the active BWP to a specific BWP that may have RACH resources and/or be suitable for BFD or RLM. The specific BWP can be controlled or indicated by the network. As such, the power consumption of the UE and delay due to SCG activation are reduced, and thus the UE performance can be improved.

### FIELD

Embodiments of the present disclosure generally relate to the field of telecommunication and in particular, to devices, methods, apparatus and computer readable storage media of secondary cell activation and deactivation.

### BACKGROUND

In dual connectivity (DC), a UE can be served by a master cell group (MCG) and a secondary cell group (SCG). The MCG and SCG may respectively include a primary cell (PCell) and a primary secondary cell (PSCell), as well as one or more secondary cell (SCell). Typically, the PSCell is assumed to be always active, when the DC is configured. With the development of communication technology, it has been proposed to allow the PSCell and thus the whole SCG to be deactivated. This is beneficial for the UE to save power and/or allows a fast SCG activation. Since releasing and adding SCG take time and costs in terms of several procedures and signaling implemented at the UE and the network, the SCG deactivation aims to achieve a better UE performance with manageable cost of UE's power consumption.

In NR communication systems, multiple bandwidth parts (BWPs) are configured for the UE. Specifically, the UE may initiate random access on the initial BWP. After the UE enters the RRC_CONNECTED mode, the network may configure the UE with dedicated BWPs including an active BWP and default BWP. The UE may then switch to the dedicated BWP, and only one BWP is active at any time, while the rest of the dedicated BWPs remain inactive. For the legacy SCell, the downlink (DL) BWP and uplink (UL) BWP indicated by firstActiveDownlinkBWP-Id and firstActiveUplinkBWP-Id respectively are activated when a SCell is activated. The current active BWP is deactivated when the SCell is deactivated. When the SCell is deactivated, basically there is no activity for the deactivated BWP(s) other than RRM measurement. Recently, it has been agreed that the UE should perform radio link monitoring (RLM) and beam failure detection (BFD) on the PSCell while the SCG is deactivated. It is also expected that the UE can perform the random access procedure when the PSCell or the SCG is activated. Based on the conventional BWP configuration, above mentioned operations and procedures may not be supported on the BWP where the UE stays when the PSCell or the SCG is deactivated or activated.

### SUMMARY

In general, example embodiments of the present disclosure provide a solution for secondary cell activation and deactivation.

In a first aspect, there is provided a terminal device. The terminal device comprises: at least one processor; and at least one memory including computer program codes. The at least one memory and the computer program codes are configured to, with the at least one processor, cause the terminal device to: receive an indication of deactivating a serving cell of the terminal device, the serving cell being provided by a second network device; determine a switching from an active bandwidth part, BWP, to a target BWP to be performed on the serving cell; and switch from the active BWP to the target BWP on the serving cell.

In a second aspect, there is provided a first network device. The first network device comprises: at least one processor; and at least one memory including computer program codes. The at least one memory and the computer program codes are configured to, with the at least one processor, cause the first network device to: transmit, to a terminal device, an indication of deactivating a serving cell of the terminal device, the serving cell being provided by a second network device; and determine a switching from an active bandwidth part, BWP, to a target BWP to be performed, by the terminal device, on the serving cell.

In a third aspect, there is provided a method. The method comprises: receiving, at a terminal device, an indication of deactivating a serving cell of the terminal device, the serving cell being provided by a second network device; determining a switching from an active bandwidth part, BWP, to a target BWP to be performed on the serving cell; and switching from the active BWP to the target BWP on the serving cell.

In a fourth aspect, there is provided a method. The method comprises: transmitting, at a first network device and to a terminal device, an indication of deactivating a serving cell of the terminal device, the serving cell being provided by a second network device; and determining a switching from an active bandwidth part, BWP, to a target BWP to be performed, by the terminal device, on the serving cell.

In a fifth aspect, there is provided a first apparatus. The first apparatus comprises: means for receiving an indication of deactivating a serving cell of the first apparatus, the serving cell being provided by a third apparatus; means for determining a switching from an active bandwidth part, BWP, to a target BWP to be performed on the serving cell; and means for switching from the active BWP to the target BWP on the serving cell.

In a sixth aspect, there is provided a second apparatus. The second apparatus comprises: means for transmitting, to a first apparatus, an indication of deactivating a serving cell of the first apparatus, the serving cell being provided by a third apparatus; and means for determining a switching from an active bandwidth part, BWP, to a target BWP to be performed, by the first apparatus, on the serving cell.

In a seventh aspect, there is provided a non-transitory computer readable medium. The non-transitory computer readable medium comprises program instructions for causing an apparatus to perform the method according to the third aspect.

In an eighth aspect, there is provided a non-transitory computer readable medium. The non-transitory computer readable medium comprises program instructions for causing an apparatus to perform the method according to the fourth aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example network environment in which example embodiments of the present disclosure may be implemented;

FIG. 2 shows a schematic diagram illustrating an example BWP configuration for PSCell;

FIG. 3 shows a signaling chart illustrating an example procedure of BWP switching according to some example embodiments of the present disclosure;

FIG. 4 illustrates a flowchart of an example method for BWP switching implemented at a terminal device according to example embodiments of the present disclosure;

FIG. 5 illustrates a flowchart of an example method for BWP switching implemented at a network device according to example embodiments of the present disclosure;

FIG. 6 illustrates a simplified block diagram of an apparatus that is suitable for implementing example embodiments of the present disclosure; and

FIG. 7 illustrates a block diagram of an example computer readable medium in accordance with example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), a further sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), Integrated Access and Backhaul (IAB) node, a relay, a low power node such as a femto, a pico, and so forth, depending on the applied terminology and technology. The network device is allowed to be defined as part of a gNB such as for example in CU/DU split in which case the network device is defined to be either a gNB-CU or a gNB-DU.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

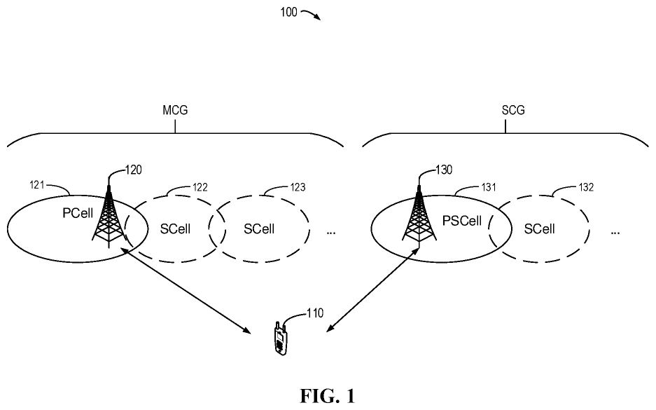

FIG. 1 illustrates an example network environment 100 in which embodiments of the present disclosure can be implemented. In the network environment 100, a terminal device 110 is configured with carrier aggregation (CA) and in DC with a first network device 120 and a second network device 130. The terminal device 110 may be implemented as a UE (which may be also referred to as the UE 110 hereinafter). The first network device 120 and the second network device 130 may be base stations for providing the terminal device 110 with radio coverage, such as, gNBs (which may be referred to as gNBs 120 and 130, or base stations 120 and 130).

As shown in FIG. 1, the first network device 120 provides and manages the MCG including a PCell 121. The PCell 121 may operate on a primary frequency, in which the terminal device 110 either performs the initial connection establishment procedure or initiates the connection re-establishment procedure. The PCell 121 is assumed to be always activated.

The second network device 130 provides and manages the SCG including a PSCell 131. For DC operations, the terminal device 110 may perform random access to the PSCell 131. Moreover, the PSCell 131 may be deactivated for the purpose of power saving, detection of MPE event, and so on.

For each of the MCG and SCG, there may be one or more SCell, for example, SCells 122, 123 and 132 configured for providing additional radio resources to the terminal device 110. However, the SCell is not essential for DC operations, and in some cases, there may be no SCell included in the MCG and SCG. It should be noted that the number of SCells in the MCG and SCG is given in illustrative purpose. Depending on network deployment, resource configuration, actual demand, etc., there may be more or less SCells in each of MCG and SCG.

The terminal device 110 may communicate with the first network device 120 and/or the second network device 130 on UL or DL. In particular, the direction from the terminal device 110 to the first network device 120 and/or the second network device 130 refers to UL, and the direction from the first network device 120 and/or the second network device 130 to the terminal device 110 refers to DL.

Only for ease of discussion, the terminal device 110 is illustrated as a UE, and the first network device 120 and the second network device 130 are illustrated as base stations. However, the UE and base station are only given as example implementations of the terminal device 110, the first network device 120 and the second network device 130, respectively, without suggesting any limitation as to the scope of the present application. Any other suitable implementations are possible as well.

It is also to be understood that the number of the devices as shown in FIG. 1 are only for the purpose of illustration without suggesting any limitations. For example, the network 100 may include any suitable number of terminal devices and network devices adapted for implementing embodiments of the present disclosure.

The communications in the network environment 100 may conform to any suitable standards including, but not limited to, LTE, LTE-evolution, LTE-advanced (LTE-A), wideband code division multiple access (WCDMA), code division multiple access (CDMA) and global system for mobile communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), and/or any further communication protocols.

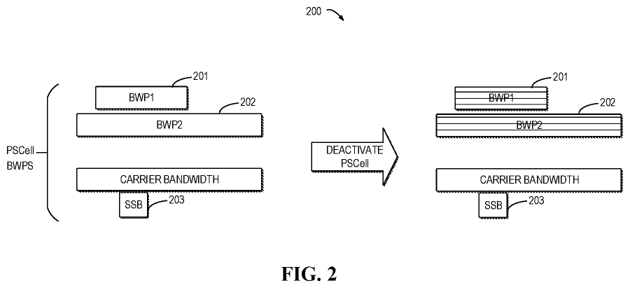

In 5G NR, the UE may be configured with multiple BWPs of the carrier bandwidth, for example, an initial BWP for random access and at least one dedicated BWP. FIG. 2 shows a schematic diagram illustrating an example BWP configuration 200 for PSCell 131. As shown in FIG. 2, the terminal device 110 is configured with the initial BWP 201, i.e., BWP1, which is the small BWP and also refers to the first active BWP. The terminal device 110 is also configured with one or more dedicated BWP 202 including BWP2 which is the full BWP. In addition, the one or more dedicated BWP 202 may or may not be associated with the SSB (synchronization signal and PBCH block) 203.

The BWP 201 may be the first active BWP and has RACH resources for performing the RA procedure, and thus the terminal device 110 initiates the RACH procedure on a SCell, e.g., PSCell 131 or SCell 132 by using BWP1. Upon entering the RRC_CONNECTED mode, the terminal device 110 may switch from the BWP 201 to one of the dedicated BWP 202. The dedicated BWP 202 that is activated first among the one or more dedicated BWP is identified by firstActiveDownlinkBWP-Id and firstActiveUplinkBWP-Id. Before the PSCell 131 is deactivated, the terminal device 110 may further switch from the dedicated BWP with firstActiveDownlinkBWP-Id and firstActiveUplinkBWP-Id to another dedicated BWP, e.g., BWP2.

The terminal device 110 may continue to use BWP2 during the PSCell 131 is deactivated. The PSCell 131 may be activated subsequently. Based on a legacy mechanism for SCell activation and deactivation, when a SCell is deactivated and then activated, the DL BWP and UL BWP identified by firstActiveDownlinkBWP-Id and firstActiveUplinkBWP-Id respectively are activated upon SCell activation. For example, when the PSCell 131 is activated, the terminal device 110 switches from BWP2 to the dedicated BWP with firstActiveDownlinkBWP-Id and firstActiveUplinkBWP-Id based on legacy configurations. However, this may not be optimal in terms of UE's power consumption and activation delay, let alone requiring additional BWP switching.

Additionally, based on legacy configurations, when a SCell is deactivated or the sCellDeactivationTimer associated with the activated SCell expires, the active BWP associated with the SCell will be deactivated. After the SCell is deactivated, basically there is no activity for the deactivated BWP other than RRM measurements. Recently, it has been proposed that the UE should perform RLM/BFD on PSCell even the SCG is deactivated. In a case that the UE is configured with a certain BWP for PSCell/SCG activation, if the network is unware of which BWP the UE is using prior to switching to the certain BWP, it is not clear about the BFD/RLM function. Moreover, the network can indicate the UE to perform the RA procedure at PSCell/SCG activation, currently there is no such triggering of RACH when a SCell is activated. In view of the above facts, the legacy mechanism of SCG activation and deactivation and configurations of BWP switching may not well support the expected technical improvements.

In order to solve the above and other potential problems, embodiments of the present disclosure provide an improved mechanism for secondary cell activation and deactivation. Based on the improved mechanism, the UE is capable of performing BWP switching at or after SCell deactivation other than upon PSCell activation. In this way, the network is aware of the BWP used when the SCG is deactivated. Additionally, the network can further configure the used TCI (transmission configuration indication) state for the PSCell at the time of SCG deactivation. As such, the UE's power consumption and activation delay due to BWP switching as well as costs of UE and network procedures are reduced. Therefore, the UE performance and the communication quality can be improved.

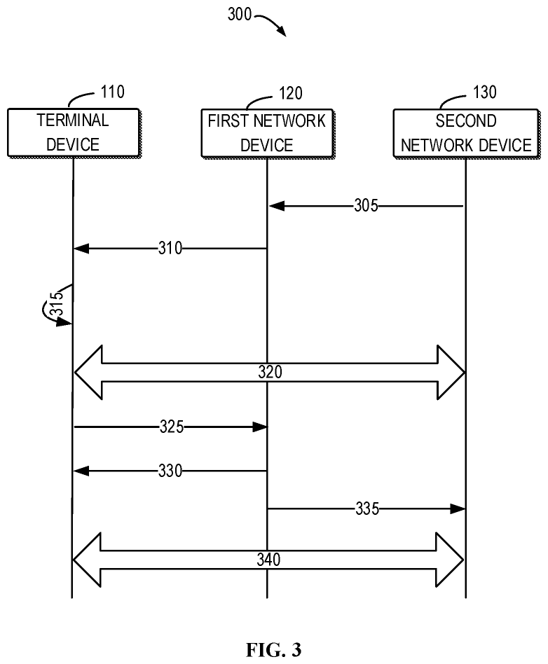

Principle and implementations of the present disclosure will be described in detail below with reference to FIG. 3. FIG. 3 shows a signaling chart illustrating an example procedure 300 of BWP switching according to some example embodiments of the present disclosure. For the purpose of discussion, the process 300 will be described with reference to FIGS. 1 and 2. The process 300 may involve the terminal device 110, the first network device 120, and the second network device 130.

In the process 300, the terminal device 110 is served by the MCG managed by the first network device 120 and the SCG managed by the second network device 130. The terminal device 110 may be served by the second network device 130 based on carrier aggregation (CA). Additionally or alternatively, the terminal device 110 may be in dual-connectivity with the first network device 120 and the second network device 130.

Moreover, the network preconfigures BWP1 as the initial BWP and BWP2 as the dedicated BWP for the PSCell 131. Accordingly, the terminal device 110 performs the RA procedure on BWP 1. After entering in RRC_CONNECTED mode, the terminal device 110 stays on BWP2, and thus the BWP 2 is the active BWP.

The second network device 130 transmits 305 a request for SCG deactivation to the first network device 120. In response to the request, the first network device 120 deactivates the PSCell 131 and thus the whole SCG, and transmits 310 a SCG deactivation message to the terminal device 110. In some examples, the second network device 130 transmits 310 a SCG deactivation message directly to the terminal device 110 without transmitting the 305 request for SCG deactivation to the first network device 120.

The terminal device 110 determines 315 a BWP switching from the active BWP (e.g., BWP2) to be performed upon the PSCell deactivation.

Since the initial BWP (e.g., BWP1) is configured with RACH resources, the terminal device 110 may determine the BWP switching to be performed from the current active BWP to the initial BWP upon receipt of the SCG deactivation message. In these embodiments, the initial BWP may be regarded as the default BWP for PSCell deactivation. Alternatively, the BWP identified by firstActiveDownlinkBWP-Id and firstActiveUplinkBWP-Id may be preconfigured as the default BWP for PSCell deactivation.

In some example embodiments, the terminal device 110 may determine the BWP switching to be performed from the current active BWP to the BWP identified by firstActiveDownlinkBWP-Id and/or firstActiveUplinkBWP-Id upon receipt of the SCG deactivation message.

Additionally, or alternatively, the BWP switching may be conditionally performed depending on configurations of the current active BWP when the PSCell/SCG is deactivated, or depending on configurations of RLM/BFD measurement for the deactivated PSCell. Accordingly, the terminal device 110 may determine whether a condition for switching BWP is met. If the condition is met, then the terminal device 110 determines that the BWP switching is to be performed upon PSCell deactivation. Otherwise, if the condition is not met, the BWP switching may be not needed for the PSCell.

In some example embodiments, the condition may be associated with RACH resources for the deactivated serving cell. In particular, upon receipt of SCG deactivation message, the terminal device 110 may determine whether the current active BWP has RACH resources. If the active BWP has no RACH resource, the terminal device 110 may determine that the condition is met, because in this case, the BWP switching from the current active BWP to a target BWP that is configured with RACH resources is needed. For example, the target BWP may be the initial BWP or a BWP identified by a next-smallest BWP ID and configured with RACH resources. Otherwise, if the active BWP has RACH resources, the terminal device 110 may determine that the condition is not met, as the BWP switching may not be needed.

In some example embodiments, the condition may be associated with configuration of RLM/BFD for the deactivated serving cell. In particular, the network may configure RLM/BFD for the PSCell 131. Upon receipt of SCG deactivation message, the terminal device 110 may determine whether the current active BWP is configured with contention free BFR resources. If the active BWP has no contention free BFR resource, the terminal device 110 may determine that the condition is met. In this case, the BWP switching from the current active BWP to a BWP that is configured with contention free BFR resource is to be performed. Otherwise, if the active BWP is configured with contention free BFR resources, the terminal device 110 may determine that the condition is not met, as BWP switching may not be needed.

In some example embodiments, the condition for switching BWP may be associated with SSB associated with the active BWP. In particular, upon receipt of SCG deactivation message, the terminal device 110 may determine whether the current active BWP is associated with the SSB. If no SSB is configured for the active BWP, the terminal device 110 may determine that the condition is met. In this case, the BWP switching from the active BWP to a BWP that is configured with SSB is to be performed. Otherwise, if the current active BWP has the associated SSB, the BWP switching may be unnecessary for the deactivated serving cell.

In the above embodiments, the determination of BWP switching as well the target BWP can be made by the terminal device 110 without indication or configuration from the network.

In some other embodiments, the network may provide explicit indication or configuration about the BWP switching. For example, the first network device 120 may transmit an indication of a target BWP to switch to the terminal device 110. The indication of a target BWP may be contained in the SCG deactivation message, or alternatively, the indication may be transmitted in a separate message from the SCG deactivation message.

The target BWP may be the BWP identified by firstActiveDownlinkBWP-Id and firstActiveUplinkBWP-Id, and in this case, the indication may be contained in legacy fields of the SCG deactivation message or in another separate message from the SCG deactivation message. Alternatively, the target BWP may be a BWP different from that is identified by firstActiveDownlinkBWP-Id and firstActiveUplinkBWP-Id, and in this case, the indication may be contained in new fields of the SCG deactivation message.

The terminal device 110 switches 320 from the current active BWP to the target BWP. In some example embodiments, the BWP switching can be performed at the time of SCG deactivation. In some other embodiments, the BWP switching may be performed upon expiration of a TAT associated with the PSCell 131 (e.g., PTAG) during the PSCell 131 is deactivated. Since both the first network device 120 and the terminal device 110 know about a TAT value associated with the PSCell 131, the BWP at the time of SCG activation is still known.

Similarly, in a case that a beam failure has been detected, after link recovery, the terminal device 110 may apply same BWP rules in the new recovered beam as configured for PSCell/SCG deactivation. A similar principle can be applied in a case that the PSCell 131 experiences RLF.

Subsequently, the terminal device 110 may transmit 325 a request for SCG activation to the first network device 120, as needed. In response to the request for SCG activation, the first network device 120 may transmit 330 a SCG activation message to the terminal device 110, and activate 335 the PSCell 131 and the SCG.

Upon receipt of the SCG activation message, the terminal device 110 determines the PSCell 131 has been activated. The terminal device 110 then communicates 340 with the first network device 120 and the second network device 130 by using the target BWP.

It should be understood that, the descriptions are provided in connection with the PSCell 131, the BWP switching mechanism upon SCG deactivation can be applicable to SCell including PUCCH SCell as well to reduce activation delay. The mechanism works similarly as for the examples of PSCell, except that since there is no RLF for SCell, the BWP switching triggering is slightly different.

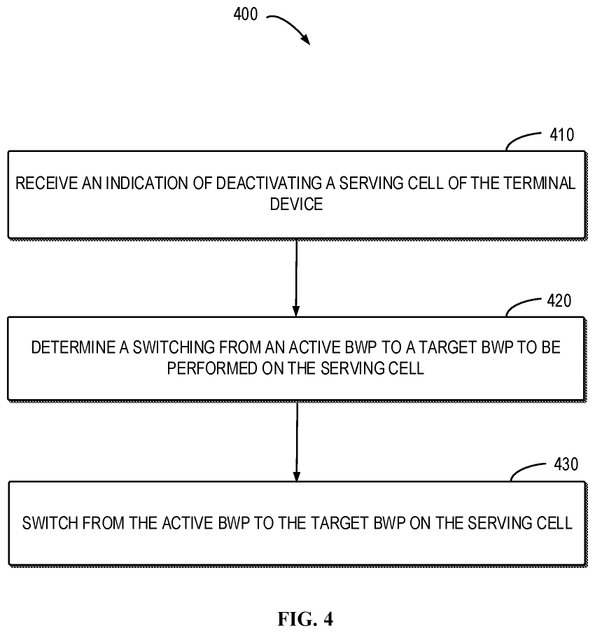

FIG. 4 illustrates a flowchart of an example method 400 for BWP switching implemented at a terminal device according to example embodiments of the present disclosure. The method 400 can be implemented at the terminal device 110 shown in FIG. 1 or any other suitable device. For the purpose of discussion, the method 400 will be described with reference to FIG. 1. It is to be understood that method 400 may further include additional blocks not shown and/or omit some shown blocks, and the scope of the present disclosure is not limited in this regard.

The terminal device 110 is served by the MCG managed by the first network device 120 and the SCG managed by the second network device 130. The terminal device 110 may be served by the second network device 130 based on carrier aggregation. Additionally or alternatively, the terminal device 110 may be in dual connectivity with the first network device 120 and the second network device 130.

Moreover, the network preconfigures BWP1 as the initial BWP and BWP2 as the dedicated BWP for the PSCell 131. Accordingly, the terminal device 110 performs the RA procedure on BWP 1. After entering in RRC_CONNECTED mode, the terminal device 110 stays on BWP2, and thus the BWP 2 is the active BWP.

At 410, the terminal device 110 receives an indication of deactivating a serving cell of the terminal device 110. The serving cell may be provided by the second network device 130, and may be the PSCell 131 or any SCell in the SCG, e.g., the SCell 132.

The indication may be contained in a deactivation message from the first network device 131. Alternatively, in a case where the second network device 130 is still active, the deactivation message may be received from the second network device 130.

At 420, the terminal device 110 determines a switching from the active BWP to a target BWP to be performed on the serving cell. The target BWP may be, for example, one of the following: an initial BWP configured for the terminal device 110, a BWP configured with a next-smallest BWP identity, a first active BWP configured for the terminal device 110 comprising a first active downlink BWP or a first active uplink BWP, a BWP configured with RACH resources, a BWP configured with contention free BFR resources, and so on.

In some example embodiments, the target BWP may be preconfigured at the terminal device 110 and the first network device 120 for the deactivation of the serving cell. The target BWP may be one of an initial BWP configured for the terminal device 110, a first active BWP configured for the terminal device 110, a BWP configured with RACH resources, a BWP configured with contention free BFR resources, and etc. Thus, in this case, the network configures the UE with the BWP dedicated to SCell deactivation in advance.

Alternatively, the target BWP may be dynamically configured or indicated by the first network device 120. In some example embodiments, the terminal device 110 may receive, from the first network device 120, an indication of the target BWP. The indication of the target BWP and the indication of deactivating the serving cell may be contained in the same message received from the first network device 120, e.g., the deactivation message. For another example, the indication of the target BWP and the indication of deactivating the serving cell may be contained in separate messages received from the first network device 120.

In the above embodiments, the terminal device 110 may receive, from the first network device 120, a configuration of TCI states for the deactivated serving cell.

Alternatively, the target BWP may be determined by the terminal device 110. In some example embodiments, the terminal device 110 may determine the target BWP for the serving cell upon the deactivation of the serving cell.

The BWP switching may be conditionally performed by the terminal device 110. In some example embodiments, the terminal device 110 may determine whether a condition for switching BWP is met. If the condition is met, the terminal device 110 then determines the switching to be performed on the serving cell. Otherwise, if the condition is not met, the terminal device 110 determines that no BWP switching is to be performed.

The condition for switching BWP may be associated with RACH resources configured with the active BWP for the serving cell. In some example embodiments, the terminal device 110 may determine whether the current active BWP has RACH resources. If no RACH resource is configured for the active BWP, the terminal device 110 may determine that the condition is met. In this case, the terminal device 110 may switch from the active BWP to a target BWP that is configured with RACH resources. Otherwise, if the current active BWP has RACH resources, the BWP switching may be unnecessary for the deactivated serving cell.

The condition for switching BWP may be associated with SSB associated with the active BWP for the serving cell. In some example embodiments, the terminal device 110 may determine whether the current active BWP is associated with a SSB. If no SSB is configured for the active BWP, the terminal device 110 may determine that the condition is met. In this case, the terminal device 110 may switch from the active BWP to a target BWP that is configured with SSB. Otherwise, if the current active BWP has the associated SSB, the BWP switching may be unnecessary for the deactivated serving cell.

The condition for switching BWP may be associated with configurations of RLM and/or BFD measurement for the serving cell. In some example embodiments, the terminal device 110 may determine whether at least one of RLM and BFD is configured for the serving cell. If so, the terminal device 110 may determine that the condition is met. The terminal device 110 may then switch to the target BWP that is indicated by the first network device 120. In this way, the network can control for which BWP the UE to stay for BFD and/or RLM when the PSCell is deactivated, and the UE's power consumption can be reduced. Otherwise, if the RLM and/or BFD are not configured for the serving cell, the BWP switching may not be necessary for the deactivated serving cell.

At 430, the terminal device 110 switches from the active BWP to the target BWP on the serving cell. In some example embodiments, the terminal device 110 may switch to the target BWP while the serving cell is deactivated upon expiration of the TAT associated with the serving cell.

In some example embodiments, the terminal device 110 may switch to the target BWP upon at least one of a beam failure or a RLF is detected on the serving cell. In a case that the beam failure is detected, after link recovery, the terminal device 110 will apply same BWP rules in the new recovered beam as configured for PSCell/SCG deactivation. In addition, a similar principle can be applied, if the PSCell 131 experiences RLF.

In some example embodiments, the BWP switching upon deactivation may be applicable to SCell including PUCCH SCell, as well to reduce activation delay. This would work similarly as for the case of PSCell, except that since there is no RLF for SCell.

In some cases, the terminal device 110 may transmit a request for SCG activation as needed. In response to the request, the first network device 120 may activate the SCG and transmit a SCG activation message to the terminal device 110. In some example embodiments, if the terminal device 110 determines that the serving cell is activated, the terminal device 110 may communicate by using the target BWP on the serving cell. In this case, the activation delay due to BWP switching can be reduced or avoided.

According to the example embodiments, there is provided an improved mechanism for secondary cell activation and deactivation. Based on the improved mechanism, the BWP switching can be performed upon PSCell or SCell deactivation, other than upon PSCell activation. Therefore, the network can be aware of the BWP used while the SCG is deactivated, and can also configure the TCI state for the PSCell at the time of SCG deactivation as needed. In this way, the UE's power consumption and activation delay due to BWP switching as well as costs of UE and network procedures are reduced. Therefore, the UE performance and the communication quality can be improved.

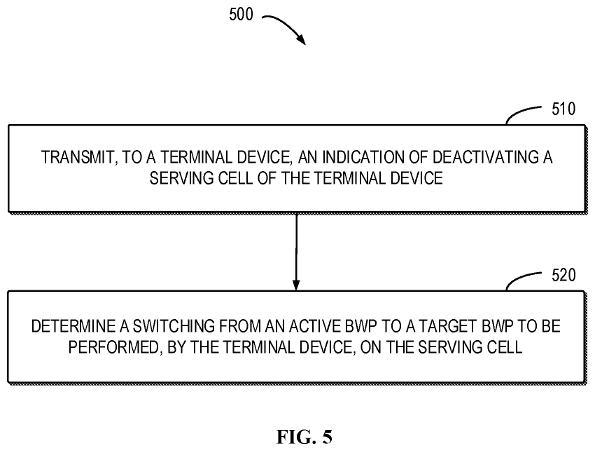

FIG. 5 illustrates a flowchart of an example method 500 for BWP switching implemented at a network device according to example embodiments of the present disclosure. The method 500 can be implemented at the first network device 120 shown in FIG. 1. For the purpose of discussion, the method 500 will be described with reference to FIG. 1. It is to be understood that method 500 may further include additional blocks not shown and/or omit some shown blocks, and the scope of the present disclosure is not limited in this regard.

The terminal device 110 is served by the MCG managed by the first network device 120 and the SCG managed by the second network device 130. The terminal device 110 may be served by the second network device 130 based on carrier aggregation. Additionally or alternatively, the terminal device 110 may be in dual connectivity with the first network device 120 and the second network device 130.

Moreover, the network preconfigures BWP1 as the initial BWP and BWP2 as the dedicated BWP for the PSCell 131. Accordingly, the terminal device 110 performs the RA procedure on BWP 1. After entering in RRC_CONNECTED mode, the terminal device 110 stays on BWP2, and thus the BWP 2 is the active BWP.

At 510, the first network device 120 transmits, to the terminal device 110, an indication of deactivating a serving cell of the terminal device 110. The serving cell may be provided by the second network device 130, and may be the PSCell 131 or any SCell in the SCG, e.g., the SCell 132. The indication may be contained in a deactivation message from the first network device 131.

In some example embodiments, the target BWP may be preconfigured at the terminal device 110 and the first network device 120 for deactivation of the serving cell. The target BWP may be one of an initial BWP configured for the terminal device 110, a first active BWP configured for the terminal device 110, a BWP configured with RACH resources, a BWP configured with contention free BFR resources, and etc. Thus, in this case, the network configures the UE with the BWP dedicated to SCell deactivation in advance.

Alternatively, the target BWP may be dynamically configured or indicated by the first network device 120. In some example embodiments, the first network device 120 may transmit, to the terminal device 110, an indication of the target BWP. The indication of the target BWP and the indication of deactivating the serving cell may be contained in the same message transmitted to the terminal device 110, e.g., the deactivation message. For another example, the indication of the target BWP and the indication of deactivating the serving cell may be contained in separate messages transmitted to the terminal device 110.

In the above embodiments, the first network device 120 may transmit, to the terminal device 110, a configuration of TCI states for the deactivated serving cell.

At 520, the first network device 120 determines a switching from an active BWP to a target BWP to be performed, by the terminal device 110, on the serving cell. The target BWP may be, for example, one of the following: an initial BWP configured for the terminal device 110, a BWP configured with a next-smallest BWP identity, a first active BWP configured for the terminal device 110 comprising a first active downlink BWP or a first active uplink BWP, a BWP configured with RACH resources, a BWP configured with contention free BFR resources, and so on.

The BWP switching may be conditionally performed by the terminal device 110. In some example embodiments, the first network device 120 may determine whether a condition for switching BWP is met. If the condition is met, the first network device 120 then determines the switching to be performed on the serving cell. Otherwise, if the condition is not met, the first network device 120 determines that no BWP switching is to be performed by the terminal device 110.

The condition for switching BWP may be associated with RACH resources configured with the active BWP for the serving cell. In some example embodiments, the first network device 120 may determine whether the current active BWP has RACH resources. If no RACH resource is configured for the active BWP, the first network device 120 may determine that the condition is met. In this case, BWP switching from the active BWP to a target BWP that is configured with RACH resources is to be performed by the terminal device 110. Otherwise, if the current active BWP has RACH resources, the BWP switching may be unnecessary for the deactivated serving cell.

The condition for switching BWP may be associated with SSB associated with the active BWP for the serving cell. In some example embodiments, the first network device 120 may determine whether the current active BWP is associated with a SSB. If no SSB is configured for the active BWP, the first network device 120 may determine that the condition is met. In this case, BWP switching from the active BWP to a target BWP that is configured with SSB is to be performed by the terminal device 110. Otherwise, if the current active BWP has the associated SSB, the BWP switching may be unnecessary for the deactivated serving cell.

The condition for switching BWP may be associated with configurations of RLM and/or BFD measurement for the serving cell. In some example embodiments, the first network device 120 may determine whether at least one of RLM and BFD is configured for the serving cell. If so, the first network device 120 may determine that the condition is met. In this case, the terminal device 110 may then switch to the target BWP that is indicated by the first network device 120. In this way, the network can control for which BWP the UE to stay for BFD and/or RLM when the PSCell is deactivated, and the UE's power consumption can be reduced. Otherwise, if the RLM and/or BFD are not configured for the serving cell, the BWP switching may not be necessary for the deactivated serving cell.

In some example embodiments, the first network device 120 may determine the switching to be performed upon expiration of the TAT associated with the serving cell while the serving cell is deactivated.

In some example embodiments, the first network device 120 may determine the switching to be performed upon at least one of a beam failure or a RLF is detected on the serving cell. In some example embodiments, the BWP switching upon deactivation may be applicable to SCell including PUCCH SCell, as well to reduce activation delay. This would work similarly as for the case of PSCell, except that since there is no RLF for SCell.

In some cases, the first network device 120 may receive a request for SCG activation from the terminal device 110. In response to the request, the first network device 120 may activate the SCG and transmit a SCG activation message to the terminal device 110. Since the BWP switching is performed upon SCG deactivation, the first network device 120 is aware of the BWP used for SCG activation. As such, he activation delay due to BWP switching can be reduced or avoided.

According to the example embodiments, there is provided an improved mechanism for secondary cell activation and deactivation. Based on the improved mechanism, the UE determines whether to perform BWP switching from the active BWP to a specific BWP that may have RACH resources and/or be suitable for BFD or RLM upon SCG deactivation. The specific BWP can be controlled or indicated by the network. As such, the power consumption of the UE and delay due to SCG activation are reduced, and thus the UE performance can be improved.

In some example embodiments, a first apparatus capable of performing any of the method 400 (for example, the terminal device 110) may comprise means for performing the respective steps of the method 400. The means may be implemented in any suitable form. For example, the means may be implemented in a circuitry or software module.

In some example embodiments, the first apparatus comprises: means for receiving an indication of deactivating a serving cell of the first apparatus, the serving cell being provided by a third apparatus; means for determining a switching from an active bandwidth part, BWP, to a target BWP to be performed on the serving cell; and means for switching from the active BWP to the target BWP on the serving cell.

In some example embodiments, the target BWP is preconfigured at the first apparatus and a second apparatus for the deactivation of the serving cell, and the target BWP comprises one of the following: an initial BWP configured for the first apparatus, a first active BWP configured for the first apparatus, a BWP configured with random access channel, RACH, resources, or a BWP configured with contention free beam failure recovery, BFR, resources.

In some example embodiments, the first apparatus further comprises: means for upon the deactivation of the serving cell, determining the target BWP for the serving cell.

In some example embodiments, the means for determining the target BWP comprises: means for receiving, from a second apparatus, an indication of the target BWP, the indication of the target BWP and the indication of deactivating the serving cell being contained in the same message received from the second apparatus.

In some example embodiments, the first apparatus further comprises: means for receiving, from a second apparatus, a configuration of transmission configuration indication, TCI, states for the deactivated serving cell.

In some example embodiments, the target BWP comprises one of the following: an initial BWP configured for the first apparatus, a BWP configured with a next-smallest BWP identity, a first active BWP configured for the first apparatus, comprising a first active downlink BWP or a first active uplink BWP, a BWP configured with random access channel, RACH, resources, or a BWP configured with contention free beam failure recovery, BFR, resources.

In some example embodiments, the means for determining the switching to be performed comprises: means for in accordance with a determination that a condition for switching BWP is met, determining the switching to be performed on the serving cell.

In some example embodiments, the first apparatus further comprises: means for in accordance with a determination that no random access channel, RACH, resource is configured for the active BWP, determining that the condition is met.

In some example embodiments, the first apparatus further comprises: means for in accordance with a determination that no synchronization signal and PBCH block, SSB, is configured for the active BWP, determining that the condition is met.

In some example embodiments, the first apparatus further comprises: means for in accordance with a determination that at least one of radio link monitor, RLM, and beam failure detection, BFD, is configured for the serving cell, determine that the condition is met.

In some example embodiments, the indication of deactivation the serving cell is received from one of the second apparatus or the third apparatus.

In some example embodiments, the first apparatus is served by the third apparatus based on carrier aggregation.

In some example embodiments, the first apparatus is in dual connectivity with a second apparatus and the third apparatus.

In some example embodiments, the means for switching to the target BWP comprises: means for upon expiration of a time alignment timer associated with the serving cell, switching to the target BWP while the serving cell is deactivated.

In some example embodiments, the means for switching to the target BWP comprises: means for upon at least one of a beam failure or a radio link failure is detected on the serving cell, switching to the target BWP.

In some example embodiments, the first apparatus further comprises: means for in accordance with a determination that the serving cell is activated, communicating by using the target BWP on the serving cell.

In some example embodiments, the serving cell comprises one of a primary secondary cell in a secondary cell group or a secondary cell configured for the first apparatus.

In some example embodiments, the first apparatus comprises a terminal device, the second apparatus comprises a network device, and the third apparatus comprises a further network device.

In some example embodiments, a second apparatus capable of performing any of the method 500 (for example, the first network device 120) may comprise means for performing the respective steps of the method 500. The means may be implemented in any suitable form. For example, the means may be implemented in a circuitry or software module.

In some example embodiments, the second apparatus comprises: means for transmitting, to a first apparatus, an indication of deactivating a serving cell of the first apparatus, the serving cell being provided by a third apparatus; and means for determining a switching from an active bandwidth part, BWP, to a target BWP to be performed, by the first apparatus, on the serving cell.

In some example embodiments, the target BWP is preconfigured at the first apparatus and the second apparatus for the deactivation of the serving cell, and the target BWP comprises one of the following: an initial BWP configured for the first apparatus, a first active BWP configured for the first apparatus, a BWP configured with random access channel, RACH, resources, or a BWP configured with contention free beam failure recovery, BFR, resources.

In some example embodiments, the second apparatus further comprises: means for transmitting, to the first apparatus, an indication of the target BWP, the indication of the target BWP and the indication of deactivating the serving cell being contained in the same message transmitted to the first apparatus.

In some example embodiments, the second apparatus further comprises: means for transmitting, to the first apparatus, a configuration of transmission configuration indication, TCI, states for the deactivated serving cell.

In some example embodiments, the target BWP comprises one of the following: an initial BWP configured for the first apparatus, a BWP configured with a next-smallest BWP identity, a first active BWP configured for the first apparatus, comprising a first active downlink BWP or a first active uplink BWP, a BWP configured with random access channel, RACH, resources, or a BWP configured with contention free beam failure recovery, BFR, resources.

In some example embodiments, the means for determining the switching to be performed comprises: means for in accordance with a determination that a condition for switching BWP is met, determining the switching to be performed on the serving cell.

In some example embodiments, the second apparatus further comprises: means for in accordance with a determination that no random access channel, RACH, resource is configured for the active BWP, determining that the condition is met.

In some example embodiments, the second apparatus further comprises: means for in accordance with a determination that no synchronization signal and PBCH block, SSB, is configured for the active BWP, determining that the condition is met.

In some example embodiments, the second apparatus further comprises: means for in accordance with a determination that at least one of radio link monitor, RLM, and beam failure detection, BFD, is configured for the serving cell, determining that the condition is met.

In some example embodiments, the means for determining the switching to be performed comprises: means for determining the switching to be performed upon expiration of a time alignment timer associated with the serving cell while the serving cell is deactivated.

In some example embodiments, the means for determining the switching to be performed comprises: means for determining the switching to be performed upon at least one of a beam failure or a radio link failure is detected on the serving cell.

In some example embodiments, the second apparatus further comprises: means for receiving, from the first apparatus, a request for activating the serving cell; and means for activating the serving cell with a knowledge of the target BWP being used for the serving cell.

In some example embodiments, the first apparatus is served by the third apparatus based on carrier aggregation.

In some example embodiments, the first apparatus is in dual connectivity with a second apparatus and the third apparatus.

In some example embodiments, the serving cell comprises one of a primary secondary cell in a secondary cell group or a secondary cell configured for the first apparatus.

In some example embodiments, the first apparatus comprises a terminal device, the second apparatus comprises a network device, and the third apparatus comprises a further network device.

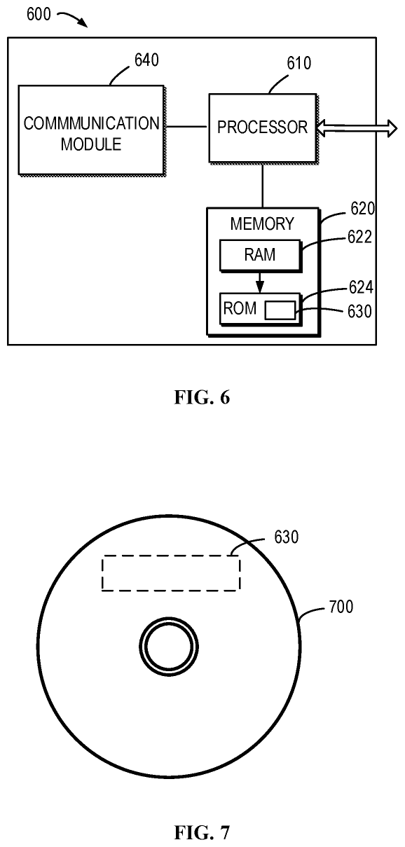

FIG. 6 is a simplified block diagram of a device 600 that is suitable for implementing embodiments of the present disclosure. The device 600 may be provided to implement the communication device, for example the terminal device 110, the first network device 120 and the second network device 130 as shown in FIG. 1. As shown, the device 600 includes one or more processors 610, one or more memories 620 coupled to the processor 610, and one or more transmitters and/or receivers (TX/RX) 640 coupled to the processor 610.

The TX/RX 640 may be configured for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage media. Examples of the volatile memories include, but are not limited to, a random access memory (RAM) 622 and other volatile memories that will not last in the power-down duration.

A computer program 630 includes computer executable instructions that may be executed by the associated processor 610. The program 630 may be stored in the ROM 624. The processor 610 may perform any suitable actions and processing by loading the program 630 into the RAM 622.

The embodiments of the present disclosure may be implemented by means of the program 630 so that the device 600 may perform any process of the disclosure as discussed with reference to FIG. 3. The embodiments of the present disclosure may also be implemented by hardware or by a combination of software and hardware.

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7. shows an example of the computer readable medium 700 in form of CD or DVD. The computer readable medium has the program 630 stored thereon.

Various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations. It is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 400 or 500 as described above with reference to FIGS. 4-5. Generally, program modules may include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1. A terminal device, comprising:
at least one processor; and
at least one memory including computer program codes;
the at least one memory and the computer program codes are configured to, with the at least one processor, cause the terminal device at least to:
receive an indication of deactivating a serving cell of the terminal device, the serving cell being provided by a second network device;
determine a switching from an active bandwidth part, BWP, to a target BWP to be performed on the serving cell; and
switch from the active BWP to the target BWP on the serving cell.

2. The terminal device of claim 1, wherein the target BWP is preconfigured at the terminal device and a first network device for the deactivation of the serving cell, and the target BWP comprises one of the following:
an initial BWP configured for the terminal device,
a first active BWP configured for the terminal device,
a BWP configured with random access channel, RACH, resources, or
a BWP configured with contention free beam failure recovery, BFR, resources.

3. The terminal device of claim 1, wherein the at least one memory and the computer program codes are configured to, with the at least one processor, further cause the terminal device to:
upon the deactivation of the serving cell, determine the target BWP for the serving cell.

4. The terminal device of claim 3, wherein the at least one memory and the computer program codes are configured to, with the at least one processor, cause the terminal device to determine the target BWP by:
receiving, from a first network device, an indication of the target BWP, the indication of the target BWP and the indication of deactivating the serving cell being contained in the same message received from the first network device.

5. The terminal device of claim 4, wherein the at least one memory and the computer program codes are configured to, with the at least one processor, further cause the terminal device to:
receive, from a first network device, a configuration of transmission configuration indication, TCI, states for the deactivated serving cell.

6. The terminal device of claim 1, wherein the target BWP comprises one of the following:
an initial BWP configured for the terminal device,
a BWP configured with a next-smallest BWP identity,
a first active BWP configured for the terminal device, comprising a first active downlink BWP or a first active uplink BWP,
a BWP configured with random access channel, RACH, resources, or
a BWP configured with contention free beam failure recovery, BFR, resources.

7. The terminal device of claim 1, wherein the at least one memory and the computer program codes are configured to, with the at least one processor, cause the terminal device to determine the switching to be performed by:
in accordance with a determination that a condition for switching BWP is met, determining the switching to be performed on the serving cell.

8. The terminal device of claim 7, wherein the at least one memory and the computer program codes are configured to, with the at least one processor, further cause the terminal device to:
in accordance with a determination that no random access channel, RACH, resource is configured for the active BWP, determine that the condition is met.

9. The terminal device of claim 7, wherein the at least one memory and the computer program codes are configured to, with the at least one processor, further cause the terminal device to:
in accordance with a determination that no synchronization signal and PBCH block, SSB, is configured for the active BWP, determine that the condition is met.

10. The terminal device of claim 7, wherein the at least one memory and the computer program codes are configured to, with the at least one processor, further cause the terminal device to:
in accordance with a determination that at least one of radio link monitor, RLM, and beam failure detection, BFD, is configured for the serving cell, determine that the condition is met.

11. The terminal device of claim 1, wherein the indication of deactivation the serving cell is received from one of the first network device or the second network device.

12. The terminal device of claim 1, wherein the terminal device is served by the second network device based on carrier aggregation.

13. The terminal device of claim 1, wherein the terminal device is in dual connectivity with a first network device and the second network device.

14. The terminal device of claim 1, wherein the at least one memory and the computer program codes are configured to, with the at least one processor, cause the terminal device to switch to the target BWP by:
upon expiration of a time alignment timer associated with the serving cell, switching to the target BWP while the serving cell is deactivated.

15. The terminal device of claim 1, wherein the at least one memory and the computer program codes are configured to, with the at least one processor, cause the terminal device to switch to the target BWP by:
upon at least one of a beam failure or a radio link failure is detected on the serving cell, switching to the target BWP.

16. The terminal device of claim 1, wherein the at least one memory and the computer program codes are configured to, with the at least one processor, further cause the terminal device to:
in accordance with a determination that the serving cell is activated, communicate by using the target BWP on the serving cell.

17. The terminal device of claim 1, wherein the serving cell comprises one of a primary secondary cell in a secondary cell group or a secondary cell configured for the terminal device.

18. A first network device, comprising:
at least one processor; and
at least one memory including computer program codes;
the at least one memory and the computer program codes are configured to, with the at least one processor, cause the first network device at least to:
transmit, to a terminal device, an indication of deactivating a serving cell of the terminal device, the serving cell being provided by a second network device; and
determine a switching from an active bandwidth part, BWP, to a target BWP to be performed, by the terminal device, on the serving cell.

19. The first network device of claim 18, wherein the target BWP is preconfigured at the terminal device and the first network device for the deactivation of the serving cell, and the target BWP comprises one of the following:
an initial BWP configured for the terminal device,
a first active BWP configured for the terminal device,
a BWP configured with random access channel, RACH, resources, or
a BWP configured with contention free beam failure recovery, BFR, resources.

20. The first network device of claim 18, wherein the at least one memory and the computer program codes are configured to, with the at least one processor, further cause the first network device to:
transmit, to the terminal device, an indication of the target BWP, the indication of the target BWP and the indication of deactivating the serving cell being contained in the same message transmitted to the terminal device.

21. The first network device of claim 20, wherein the at least one memory and the computer program codes are configured to, with the at least one processor, further cause the first network device to:
transmit, to the terminal device, a configuration of transmission configuration indication, TCI, states for the deactivated serving cell.

22. The first network device of claim 18, wherein the target BWP comprises one of the following:
an initial BWP configured for the terminal device,
a BWP configured with a next-smallest BWP identity,
a first active BWP configured for the terminal device, comprising a first active downlink BWP or a first active uplink BWP,
a BWP configured with random access channel, RACH, resources, or
a BWP configured with contention free beam failure recovery, BFR, resources.

23. The first network device of claim 18, wherein the at least one memory and the computer program codes are configured to, with the at least one processor, cause the first network device to determine the switching to be performed by:
in accordance with a determination that a condition for switching BWP is met, determining the switching to be performed on the serving cell.

24. The first network device of claim 23, wherein the at least one memory and the computer program codes are configured to, with the at least one processor, further cause the first network device to:
in accordance with a determination that no random access channel, RACH, resource is configured for the active BWP, determine that the condition is met.

25. The first network device of claim 23, wherein the at least one memory and the computer program codes are configured to, with the at least one processor, further cause the first network device to:
in accordance with a determination that no synchronization signal and PBCH block, SSB, is configured for the active BWP, determine that the condition is met.

26. The first network device of claim 23, wherein the at least one memory and the computer program codes are configured to, with the at least one processor, further cause the first network device to:
in accordance with a determination that at least one of radio link monitor, RLM, and beam failure detection, BFD, is configured for the serving cell, determine that the condition is met.

27. The first network device of claim 18, wherein the at least one memory and the computer program codes are configured to, with the at least one processor, cause the first network device to determine the switching to be performed by:
determining the switching to be performed upon expiration of a time alignment timer associated with the serving cell while the serving cell is deactivated.

28. The first network device of claim 18, wherein the at least one memory and the computer program codes are configured to, with the at least one processor, with the at least one processor, cause the first network device to determine the switching to be performed by:
determining the switching to be performed upon at least one of a beam failure or a radio link failure is detected on the serving cell.

29. The first network device of claim 18, wherein the at least one memory and the computer program codes are configured to, with the at least one processor, further cause the first network device to:
receive, from the terminal device, a request for activating the serving cell; and
activate the serving cell with a knowledge of the target BWP being used for the serving cell.

30. The first network device of claim 18, wherein the terminal device is served by the second network device based on carrier aggregation.

31. The first network device of claim 18, wherein the terminal device is in dual connectivity with a first network device and the second network device.

32. The first network device of claim 18, wherein the serving cell comprises one of a primary secondary cell in a secondary cell group or a secondary cell configured for the terminal device.

33. A method comprising:
receiving, at a terminal device, an indication of deactivating a serving cell of the terminal device, the serving cell being provided by a second network device;
determining a switching from an active bandwidth part, BWP, to a target BWP to be performed on the serving cell; and
switching from the active BWP to the target BWP on the serving cell.

34. A method comprising:
transmitting, at a first network device and to a terminal device, an indication of deactivating a serving cell of the terminal device, the serving cell being provided by a second network device; and
determining a switching from an active bandwidth part, BWP, to a target BWP to be performed, by the terminal device, on the serving cell.

35. A first apparatus comprising:
means for receiving an indication of deactivating a serving cell of the first apparatus, the serving cell being provided by a third apparatus;
means for determining a switching from an active bandwidth part, BWP, to a target BWP to be performed on the serving cell; and
means for switching from the active BWP to the target BWP on the serving cell.

36. A second apparatus comprising:
means for transmitting, to a first apparatus, an indication of deactivating a serving cell of the first apparatus, the serving cell being provided by a third apparatus; and
means for determining a switching from an active bandwidth part, BWP, to a target BWP to be performed, by the first apparatus, on the serving cell.

37. A non-transitory computer readable medium comprising program instructions for causing an apparatus to perform at least:
receiving, at a terminal device, an indication of deactivating a serving cell of the terminal device, the serving cell being provided by a second network device;
determining a switching from an active bandwidth part, BWP, to a target BWP to be performed on the serving cell; and
switching from the active BWP to the target BWP on the serving cell.

38. A non-transitory computer readable medium comprising program instructions for causing an apparatus to perform at least:
transmitting, at a first network device and to a terminal device, an indication of deactivating a serving cell of the terminal device, the serving cell being provided by a second network device; and
determining a switching from an active bandwidth part, BWP, to a target BWP to be performed, by the terminal device, on the serving cell.
